(19) United States
(12) Patent Application Publication
(10) Pub. No.: US 2018/0293828 A1
(43) Pub. Date: Oct. 11, 2018

(54) HANDHELD TRANSMITTER AND MOTOR VEHICLE

(71) Applicant: GM GLOBAL TECHNOLOGY OPERATIONS LLC, Detroit, MI (US)

(72) Inventor: Joerg GSCHWENG, Ruesselsheim (DE)

(73) Assignee: GM GLOBAL TECHNOLOGY OPERATIONS LLC, Detroit, MI (US)

(21) Appl. No.: 15/266,413

(22) Filed: Sep. 15, 2016

(30) Foreign Application Priority Data
Sep. 15, 2016 (DE) 102015012131.6

(51) Int. Cl. G07C 9/00

(52) U.S. Cl. CPC G07C 9/00944

(57) ABSTRACT

A handheld transmitter includes a housing having at least one key a key cover and a switch that can be actuated by the key. The switch is located inside the housing, wherein a flexible membrane is arranged between the key cover and switch. The membrane includes a reinforcement in a contact area between the key cover and switch.

### CROSS-REFERENCE TO RELATED APPLICATION

This application claims priority to German Patent Application No. 102015012131.6, filed Sep. 17, 2015, which is incorporated herein by reference in its entirety.

### TECHNICAL FIELD

The present disclosure pertains to a handheld transmitter and a motor vehicle.

### BACKGROUND

A demand exists today for wearable electronic user devices, such as electronic keys or radio keys, which are intended to enable any design variant with any key shape desired by the customer. In addition, efforts are increasingly being made to reduce the dimensions, in particular the overall height, of the wearable electronic user devices, so as to improve wearing comfort. The problem here is that the variety of design in particular for the keys to be actuated by a user must ensure that actuating these keys also triggers a corresponding switch element, so as to perform a corresponding function, like transmitting a door unlocking signal for a vehicle.

DE 10 2013 205 689 B3 discloses a wearable electronic user device, in particular an electronic key. The electronic key includes a dimensionally stable key to be actuated by the user and a flexibly deformable membrane. The membrane has a first side with at least one bearing portion on which the at least one key is mounted via a plunger, and an actuating section separate from the at least one bearing section for receiving and relaying an actuation of the key to an electrical switch element and a second side opposite the first side. The electronic key further includes an intrinsically dimensionally stable frame, which carries the membrane on its second side. The frame has at least one opening in the area of the at least one bearing section, through which the membrane can be moved when actuating the at least one key, and generates a force for resetting the key as a function of the size and/or shape of the opening.

The membrane is exposed to a mechanical load when actuated, and thus is subject to wear. The membrane can harden, can become brittle, can tear and the like. Damaged membranes may no longer be moisture-proof on the one hand, so that liquid can easily penetrate inside a corresponding handheld transmitter, which can lead to a malfunction. Given corresponding damage to the membrane, mechanical components can additionally become jammed, which can also cause the corresponding key to fail.

As a consequence, there is a need to further develop handheld transmitters of the kind mentioned at the outset to give them a longer service life.

### SUMMARY

In accordance with the present disclosure, a handheld transmitter is provide with a casing having at least one key, which includes a key cover and a switch that can be actuated by the key cover. The switch is located inside the housing and a flexible membrane is arranged between the key cover and switch. The membrane includes a reinforcement in a contact area between the key cover and switch.

Corresponding handheld transmitters can be used for remotely unlocking a motor vehicle, which is why they are often colloquially referred to as keys. In addition, they can be used to identify the driver and trigger an immobilizer. The handheld transmitter can include a mechanical key, for example in beard form, or make do without a corresponding key. The housing can incorporate several keys. The keys can have varying functions. The keys can have varying functions assigned to them in different operating modes. Depending on how a specific key is actuated, for example by briefly pressing, pressing twice, or continuously pressing, the key can implement various functions.

The housing can incorporate additional components, for example a power supply, a transmitter, a receiver, light-emitting diodes, microprocessors and the like. The membrane can be sealing in design, so that the membrane provides a moisture barrier between the key and switch. To this end, the membrane can be arranged so as to peripherally abut.

Reinforcing the membrane in the contact area between the key cover and switch increases the mechanical load-bearing capacity of the membrane in this area, so that the reinforcement delays any wear to the membrane. A correspondingly equipped handheld transmitter is thus more robust than a conventional handheld transmitter. The reinforcement can slow down wear on the one hand, and better distribute the actuating forces on the other.

In a further embodiment, the reinforcement may include a different material than the membrane. As a result, the flexibility of the membrane can be retained on the one hand, and a correspondingly durable material can be used for the reinforcement on the other. This lowers the mechanical load placed on the membrane.

In another embodiment, the membrane may be formed of a silicone or TPU (thermoplastic polyurethane). Silicone and TPU remain elastic for many years, and are also well suited for establishing seals.

In a further embodiment, the reinforcement may be ABS (acrylonitrile-butadiene-styrene) or PA6 (polycaprolactam or Nylon 6). ABS and PA6 are robust, resistant materials, which are impervious to compressive stresses.

In another further embodiment, the reinforcement may be applied to the membrane. As a result, the membrane may be designed as a continuous membrane, which facilitates manufacture. Reinforcements can then be applied where required, specifically in a contact area between the key cover and switch. As an alternative, an embodiment may provide that the reinforcement be placed in the membrane. By comparison to the previous embodiment, this increases the manufacturing costs, but reduces the required installation space, since the correspondingly reinforced membrane can do without an additional layer.

A correspondingly reinforced membrane can be fabricated in the 2K injection molding process. This produces a materially integral connection between the reinforcement and membrane. 2K injection molding can be performed with precision.

Another embodiment can provide that the membrane and/or reinforcement be heat treated. A corresponding heat treatment makes it possible to improve the mechanical robustness of the membrane and/or reinforcement.

In a further embodiment, the key cover can include a key stamp that contacts the membrane or reinforcement upon actuation. This permits an increased freedom when designing the handheld transmitter and housing. The actuating force exerted on the key cover can be concentrated on the switch by the stamp, allowing for a smooth corresponding actuation.

In another embodiment, the switch can be a microswitch with protruding button. Corresponding microswitches have a flat structure and a low actuation stroke. The protruding head can enable a more precise actuation of the microswitch. In addition, corresponding microswitches are fabricated in series, and have a variety of uses. This makes manufacture correspondingly inexpensive, and the purchase price is low.

In another embodiment, the housing can include at least one stop for the key cover. A corresponding stop can be used to define the actuation stroke of the key cover, and avert an overloading of the membrane and/or switch.

In another further embodiment, the switch can be situated on a board. Corresponding boards are robust enough to absorb the actuation forces, electrically connected relatively easily by using applied conducting paths, and simple in construction and assembly of corresponding handheld transmitters.

A first independent object relates to a motor vehicle with a corresponding handheld transmitter of the aforementioned kind. Corresponding motor vehicles can be operated for a long time with little risk of failure owing to defective handheld transmitters.

### BRIEF DESCRIPTION OF THE DRAWINGS

The present invention will hereinafter be described in conjunction with the following drawing figures, wherein like numerals denote like elements.

FIG. 1 is a schematic, perspective view of a cut open handheld transmitter;

FIG. 2 is a section through the handheld transmitter on FIG. 1 in a planar, magnified depiction; and

FIG. 3 is a switch of a handheld transmitter.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

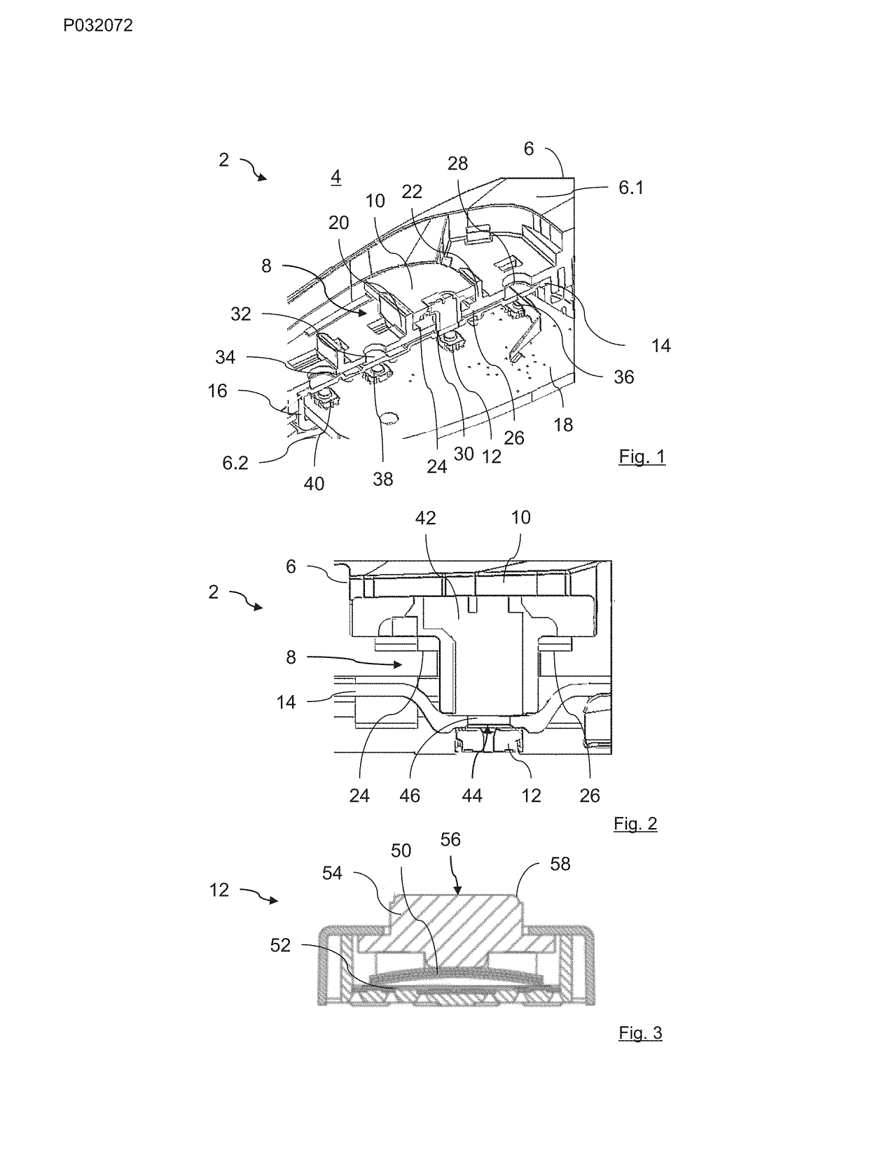

FIG. 1 shows a schematic, perspective depiction of a handheld transmitter 2 in a motor vehicle 4. The handheld transmitter 2 is shown cut open. The handheld transmitter 2 includes a housing 6. The housing 6 can have a multipart design, and in particular includes a upper housing side 6.1 and lower housing side 6.2 visible on FIG. 1.

The housing 6 incorporates a key 8. The key 8 includes a key cover 10 and a microswitch 12. A membrane 14 is located between the key cover 10 and microswitch 12. The membrane 14 may be formed with silicone, but can also include another material, in particular TPU. The membrane 14 has a sealing design, and rests on a continuously designed web 16.

The microswitch 12 is situated on a board 18. The board 18 can include conducting paths so as to relay electrical signals to a microprocessor, which can transmit radio commands in response to actuating the key 8 to a receiver of the motor vehicle 4. As relates to the actuating force of the key 8, the board 18 is also a thrust bearing for the microswitch 12.

The key cover 10 is guided between two webs 20, 22. The webs 20, 22 include stops 24, 26. The stops 24, 27 border the actuation stroke of the key cover 10, and limit the mechanical load placed on the microswitch 12 and board 18 by actuating the key 8, since once the key cover 10 has reached the stops 24, 26, additional actuating forces are diverted into the housing 6. The webs 20, 22 can be designed so as to secure the key cover 10 against loss.

The housing 6 includes several holes 28 to 34, through which corresponding microswitches 12 and 36 to 40 can be actuated. A key stamp 42 is arranged on the key cover 10, which plunges into the corresponding hole 30. The key stamp 42 touches the membrane 14. The membrane 14 becomes elastically deformed when the key cover is actuated by pressing down the key cover in the direction of the stops 24, 26, thereby establishing contact with the microswitch 12, and the microswitch 12 is triggered given a sufficient actuation stroke of the key cover 10.

A reinforcement 46 is located in the contact area 44 between the stamp 42 and microswitch 12. The reinforcement 46 consists of ABS, and in other embodiments can also consist of PA6. The reinforced membrane 14 is fabricated in a 2K injection molding process. As a result, a reinforcement can be fabricated in a plane with the membrane.

FIG. 2 shows a planar, perspective view of the handheld transmitter 2 in a pressed-down state.

The key cover 10 abuts against the stops 24, 26 of the webs 20, 22. The webs 20, 22 along with the stops 24, 26 can be designed as a single piece with the upper housing side 6.1. Pressing down the key cover 10 deforms the membrane 14, and causes it to abut against the microswitch 12. The contact area 44 is protected against mechanical wear by the reinforcement. After letting go of the membrane 14, elastically preloading the latter exerts a restoring force on the key cover 10, moving it back into its initial position.

FIG. 3 shows a cross section through a microswitch 12. The microswitch 12 includes electrical contacts 50, 52, wherein the electrical contact 50 is resilient in design. By contrast, the electrical contact 52 is rigid. A button 54 abuts against the electrical contact 50. Pressing down the button 54 shorts the electrical contacts 50, 52, and thereby closes the microswitch 12. The button 54 includes an upper side 56, which has a comparatively sharp edge 58. The edge 58 is necessitated by the production process. Post-machining the edge 48 to round it more would significantly increase the price of the microswitch 12.

In the case of handheld transmitters where the membrane has no reinforcement, the edge 58 of the known microswitch can exert a high mechanical load on the membrane, so that the latter can become damaged by the edge 58. Due to the reinforcement 46, however, the edge 58 no longer abuts against the soft membrane material, but rather against the reinforcement, so that the mechanical load acts on the significantly more robust reinforcement 46, thereby reducing the wear on the membrane 14.

The reinforcement 46 has larger dimensions than the upper side 56 of the button 54. As a consequence, the reinforcement 46 can include a larger surface than the upper side 56 of the button 54. Provided the reinforcement 46 and upper side 56 are round, the reinforcement 46 can include a larger radius than the upper side 56. This ensures that the reinforcement 46 will always come to abut against the button 54.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-13. (canceled)

14. A handheld transmitter comprising:
a housing having at least one key, the key including:
a key cover,
a switch located inside the housing, the switch including a rigid contact and a resilient contact, the resilient contact aligned with the rigid contact and the resilient contact configured to be actuated by the key cover to engage the rigid contact to operate the switch; and
a flexible membrane arranged between the key cover and the resilient contact of the switch, the flexible membrane having a flexible substrate having a first surface disposed toward the resilient contact and a second surface, different than the first surface, disposed toward the key cover, and a reinforcement formed within a common plane with the second surface in a contact area that is configured to be engaged by the key cover.

15. The handheld transmitter according to claim 14, wherein the reinforcement comprises a material which is different from a material for the flexible substrate.

16. The handheld transmitter according to claim 15, wherein the flexible substrate material is selected from the group consisting of a silicone or a thermoplastic polyurethane.

17. The handheld transmitter according to claim 16, wherein the reinforcement material is selected from the group consisting of acrylonitrile-butadiene-styrene or polycaprolactam.

18. The handheld transmitter according to claim 15, wherein the reinforcement material is selected from the group consisting of acrylonitrile-butadiene-styrene or polycaprolactam.

19. The handheld transmitter according to claim 14, wherein the reinforcement is applied to the second surface.

20. The handheld transmitter according to claim 14, wherein the reinforcement is placed in the flexible substrate adjacent the second surface.

21. The handheld transmitter according to claim 20, wherein the flexible substrate and the reinforcement are fabricated in a 2K injection molding process.

22. The handheld transmitter according to claim 14, wherein at least one of the flexible substrate and the reinforcement comprise a heat treated component.

23. The handheld transmitter according to claim 14, wherein the key cover comprises a key stamp configured to contact the reinforcement upon actuation of the switch.

24. The handheld transmitter according to claim 14, wherein the switch comprises a microswitch having a protruding button.

25. The handheld transmitter according to claim 14, wherein the housing comprises at least one stop for the key cover.

26. The handheld transmitter according to claim 14, further comprising a board on which the switch is situated.
